(19) United States
(12) Patent Application Publication
(10) Pub. No.: US 2008/0174095 A1
(43) Pub. Date: Jul. 24, 2008

(54) Energy absorption mechanism for collapsible assembly

(76) Inventors: Jason R. Ridgway, Bay City, MI (US); Jeremy A. Ponichtera, Saginaw, MI (US); Jorge Flores-Garay, Juarez (MX)

Correspondence Address: MICHAEL D. SMITH;DELPHI TECHNOLOGIES, INC., P.O. BOX 5052, MAIL CODE: 480-410-202, TROY, MI, 48007-5052, US

(21) Appl. No.: 11/654,790

(22) Filed: Jan. 18, 2007

(51) Int. Cl. B62D 1/19

(52) U.S. Cl. 280/777

(57) ABSTRACT

An energy absorption mechanism for a collapsible assembly such as a steering assembly for a vehicle. The mechanism includes first and second relatively displaceable members. The first and second members define an open gap extending in a direction transverse to the axial direction along which the assembly collapses. A metallic foam member is operably disposed between the first and second members to resist relative axial movement of the first and second members. The metallic foam member has an axially extending first portion with a transverse thickness that is greater than the transversely extending open gap. The metallic foam member is deformed as the assembly collapses and the first and second members force the metallic foam member to enter the transverse gap. By controlling the cross sectional area of the metallic foam member, the resistance force generated by the energy absorption mechanism can be controlled.

### BACKGROUND OF THE INVENTION

1. Field of the Invention

The present invention relates to energy absorption mechanisms, and, more particularly, to energy absorption mechanisms for collapsible assemblies such as a collapsible steering assembly installed in a motor vehicle.

2. Description of the Related Art

Many vehicles have collapsible steering assemblies that include energy absorption mechanisms to reduce the likelihood of injury to the driver during an accident. A variety of different energy absorption mechanisms have been developed for this purpose.

Each of these mechanisms can be characterized by what is known as the energy absorption profile of the mechanism. The energy absorption profile (“E/A profile”) can be graphically represented by a diagram plotting the force exerted by the mechanism to resist collapse of the assembly against the displacement, i.e., the distance by which the mechanism has collapsed. It will often be desirable for an energy absorption mechanism to have a peak resistance value that is just below the magnitude of a force that which will cause damage to the person, or object, that is being protected. It is also generally desirable for the profile to have a relatively long collapse distance in an effort to maximize the quantity of energy that can be absorbed by the device. In an effort to limit the peak resistance force for relatively minor impacts, it may be desirable to provide a profile that absorbs an increasing amount of energy in the initial stage of collapse. Still other characteristics may be desirable for particular applications and there is no single E/A profile that is applicable to all situations and applications. A variety of different factors may be involved in the determining the preferred E/A profile for a particular application and the ability to reliably control the E/A profile to satisfy the demands of a particular application is desirable.

### SUMMARY OF THE INVENTION

The present invention provides an improved low cost energy absorption mechanism for a collapsible assembly that employs a metallic foam member that facilitates control over the energy absorption profile of the mechanism.

The invention comprises, in one form thereof, an energy absorption mechanism for a collapsible assembly. The energy absorption mechanism includes a first member and a second member wherein the first and second members are relatively displaceable as the assembly is collapsed. The first and second members are relatively displaced from an initial configuration to a collapsed configuration during collapse of the assembly. The first member defines a first engagement portion while the second member defines a second engagement portion. The first and second engagement portions define a variable volume therebetween that has an axial extent which is progressively reduced as the first and second members move from the initial configuration toward the collapsed configuration. The first and second engagement portions also define an open gap extending in a direction transverse to the axial direction. A metallic foam member is operably disposed between the first and second engagement portions and is positioned to resist relative axial movement of the first and second members from the initial configuration toward the collapsed configuration. The metallic foam member has an axially extending first portion with a transverse thickness that is greater than the transversely extending open gap. The metallic foam member is deformed as the first and second members move from the initial configuration toward the collapsed configuration with the first portion of the metallic foam member entering the transverse gap during the movement from the initial configuration to the collapsed configuration.

In some embodiments of the energy absorption mechanism, the cross sectional area defined by the first portion of the metallic foam member, in an undeformed condition, is variable in magnitude over the axial length of the portion whereby deformation of the metallic foam member between the first and second engagement portions generates a resistance force that controllably varies as the first and second members move from the initial configuration toward the collapsed configuration.

The invention comprises, in yet another form thereof, a collapsible steering assembly for a vehicle. The steering assembly includes a collapsible housing mountable to the vehicle, a collapsible steering shaft disposed within the housing and an energy absorption mechanism operably coupled with one of the housing and the steering shaft. Movement of the energy absorption mechanism from an initial configuration to a collapsed configuration resists collapse of the housing or steering shaft with which the mechanism is coupled. The energy absorption mechanism includes a first member and a second member wherein the first and second members are relatively displaceable through first and second stages of displacement during movement of the energy absorption mechanism from the initial configuration to the collapsed configuration. The energy absorption mechanism generates a collapse resisting force with a first magnitude during the first stage of displacement and a different second magnitude during the second stage of displacement. A metallic foam member is operably disposed between the first and second members. Relative movement of the first and second members during one of the first and second stages of displacement deforms the metallic foam member and the deformation of the metallic foam member generates the collapse resisting force for that stage.

The invention comprises, in still another form thereof, a method of absorbing energy during the collapse of a steering assembly in a vehicle. The method includes disposing a metallic foam member between first and second relatively displaceable members wherein the first and second displaceable members are relatively moveable along a displacement axis during collapse of the steering assembly. The method also involves forming an open gap between the first and second displaceable members wherein the gap extends transverse to the displacement axis and forcing at least a portion of the metallic foam member into the open gap during collapse of the steering assembly to thereby cause the deformation of the metallic foam member.

In some embodiments of the method, the metallic foam member includes a diminishing section wherein the undeformed cross sectional area of the metallic foam member entering the open transverse gap progressively decreases as the steering assembly is progressively collapsed. As a result, the resistance force generated by the metallic foam member to the collapse of the steering assembly is progressively decreased.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a partially cutaway perspective view of a steering column assembly in accordance with the present invention.

FIG. 2 is a sectional view taken along line 2-2 of FIG. 1.

FIG. 3 is a schematic side view of an energy absorption mechanism.

FIG. 4 is a top view of the mechanism of FIG. 3.

FIG. 5 is an E/A profile for the mechanism of FIGS. 3 and 4.

FIG. 6 is a schematic side view of another energy absorption mechanism.

FIG. 7 is a top view of the mechanism of FIG. 6.

FIG. 8 is an E/A profile for the mechanism of FIGS. 6 and 7.

FIG. 9 is a top view of another energy absorption mechanism.

FIG. 10 is an E/A profile for the mechanism of FIG. 9.

FIG. 11 is a top view of another energy absorption mechanism.

FIG. 12 is an E/A profile for the mechanism of FIG. 11.

FIG. 13 is a top view of another energy absorption mechanism.

FIG. 14 is an E/A profile for the mechanism of FIG. 13.

FIG. 15 is a partial side view of another steering column assembly.

FIG. 16 is a partial side view of the steering column assembly of FIG. 15 after it has been subjected to an impact force.

FIG. 17 is a partial perspective view of another steering column assembly.

FIG. 18 is a sectional view of a metallic foam member useable in the steering column assemblies of FIGS. 15 and 17.

FIG. 19 is a schematic view of a steering shaft having an energy absorption mechanism.

FIG. 20 is an E/A profile of the steering shaft of FIG. 19.

FIG. 21 is a schematic view of another steering shaft having an energy absorption mechanism.

FIG. 22 is an E/A profile of the steering shaft of FIG. 21.

FIG. 23 is a schematic view of another steering shaft having an energy absorption mechanism.

FIG. 24 is an E/A profile of the steering shaft of FIG. 23.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE INVENTION

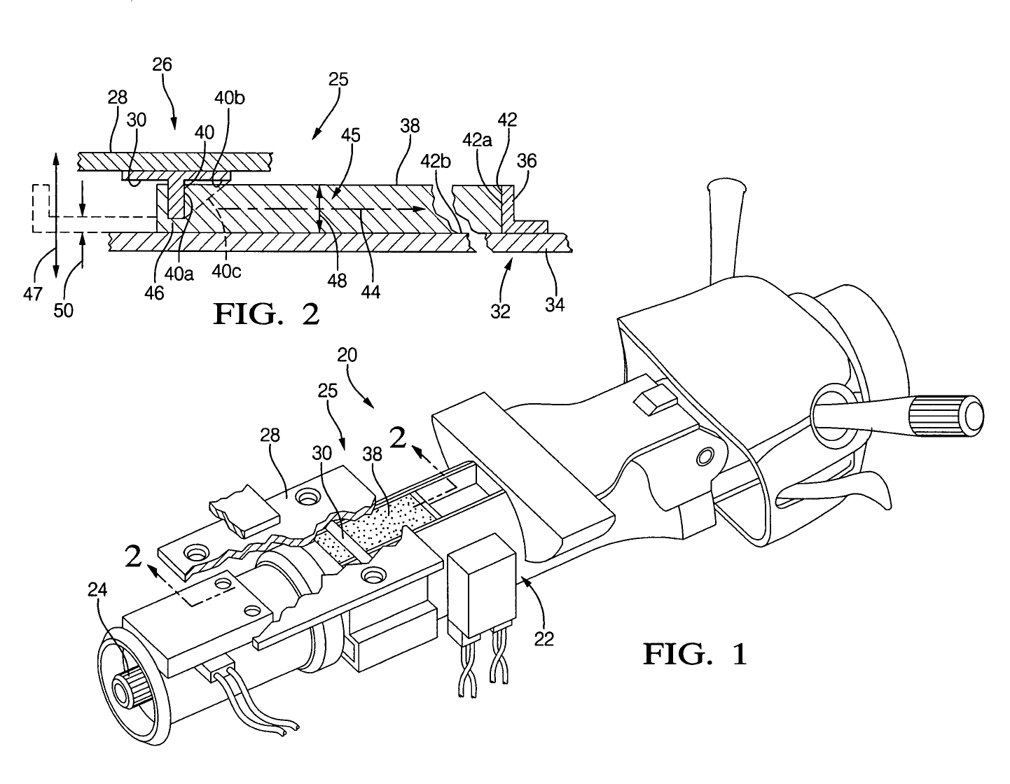

A collapsible steering assembly 20 in accordance with the present invention is illustrated in FIG. 1. Steering assembly 20 includes a collapsible housing 22 within which is a collapsible steering shaft 24. A steering wheel (not shown) controlled by the operator of the vehicle is mounted on one end of housing 22. Steering shaft 24 forms a part of the mechanical linkage communicating rotational movement between the steering wheel and the steering gear (not shown) and is rotatably disposed within housing 22.

Collapsible housing 22 includes a first housing member 26 and a second housing member 32. An energy absorption mechanism 25 is operably disposed between housing members 26 and 32. The first housing member 26 includes a mounting fixture 28 that is non-moveably fixed to the structure of the vehicle and supports steering assembly 20 within the vehicle. Housing member 26 also includes a bracket 30 having a T-shaped cross section that is secured to mounting fixture 28.

Second housing member 32 includes an outer jacket 34 that surrounds rotatable steering shaft 24 and an L-shaped bracket 36. An aluminum foam member 38 is located in a volume 45 between first and second members 26, 32. A portion 40 of first member 26 engages metallic foam member 38 and a portion 42 of second member 32 also engages metallic foam member 38 as first and second members 26, 32 relatively move during the collapse of housing 22. As housing 22 collapses, first and second members 26, 32 move relative toward each other along axis 44 thereby shrinking the volume 45 between members 26, 32 in which metallic foam member 38 is located.

As best seen in FIG. 2, first engagement portion 40 includes a surface 40a located on bracket 30 that is oriented generally transverse to axis 44 and a surface 40b on bracket 30 and mounting fixture 28 that is oriented generally parallel with axis 44. Similarly, second engagement portion 42 includes a surface 42a on bracket 36 that is oriented substantially transverse to axis 44 and a surface 42b on jacket 34 that is oriented substantially parallel with axis 44. As housing 22 collapses, surfaces 40a and 42a move toward each other along axis 44 and surfaces 40b, 42b confine metallic foam member 38 within volume 45. Line 47 is positioned at a 90 degree angle to axis 44 and, thus, is oriented transverse to axis 44.

As also shown in FIG. 2, bracket 30 and surface 42b define a transverse gap 46. The transverse thickness 48 of metallic foam member 38 is larger than gap 46 when in an undeformed condition prior to the collapse of housing 22. Consequently, as housing 22 collapses, foam member 38 will be deformed as it is forced through gap 46. The deformation of foam member 38 may be a relatively complex process with some local axial deformation taking place along with a transverse deformational compression of member 38 as it is forced through transverse gap 46. A dashed outline schematically depicts a deformed foam member 38 after it has passed through gap 46. The deformed portion of metallic foam member 38 has a reduced transverse thickness 50 approximately equal to the transverse dimension of gap 46. As housing 22 collapses and metallic foam member 38 is deformed, the deformation of foam member 38 “absorbs” energy that is applied to housing 22 by an impact force.

Various other configurations of engagement portions 40, 42 which define a transverse gap 46 may alternatively be employed. For example, instead of using a bracket 36 having a T-shaped cross section with surface 40a disposed perpendicular to axis 44, a slanted surface 40c oriented at an angle (e.g., 45 degrees) to axis 44 and inclined to guide foam member 38 toward transverse gap 46 could be alternatively employed. A variety other configurations might also be used.

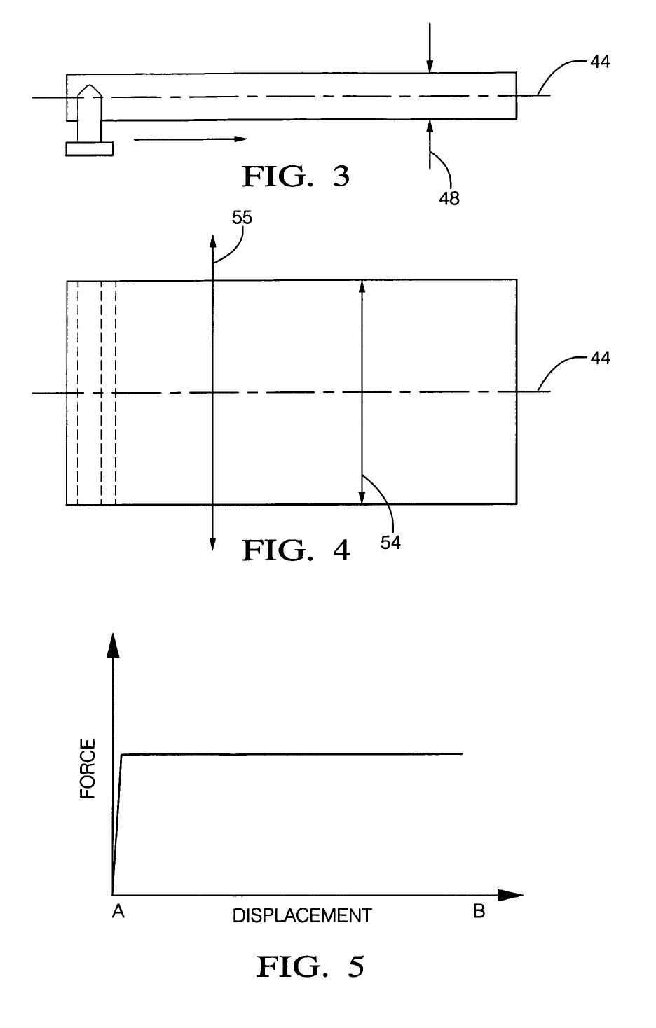

FIGS. 3-5 provide a schematic representation of E/A mechanism 25 and illustrate the E/A profile of mechanism 25. FIG. 3 presents a simplified side view of the E/A mechanism similar to that of FIG. 2. FIG. 4 presents a view showing lateral direction 55, wherein axis 44, transverse direction 47 and lateral direction 55 are all mutually perpendicular. As seen in FIG. 4, the illustrated metallic foam member has a lateral dimension 54 that is substantially constant over the entire axial length of the member.

The resistance force generated by metallic foam member 38 to the collapse of housing 22 will depend on a number of factors including the density and other physical parameters of foam member 38. In the illustrated embodiment, foam block 38 is an aluminum foam block having substantially uniform physical properties throughout the block. The foam block of FIGS. 1-4 also has a cross section throughout its length along axis 44 that does not vary and, as a result, the force required to force metallic foam member 38 through transverse gap 46 will remain substantially constant as housing 22 collapses. FIG. 5 depicts a simplified E/A profile of the metallic foam block of FIGS. 1-4 which graphically represents a constant resistance force being exerted by foam member 38 as first and second members 26, 32 are displaced relative to each other along axis 44. It is noted that the E/A profile depicted in FIG. 5 is an idealized E/A profile and actual measured values for E/A mechanism 25 are likely to display some variation as housing 22 collapses.

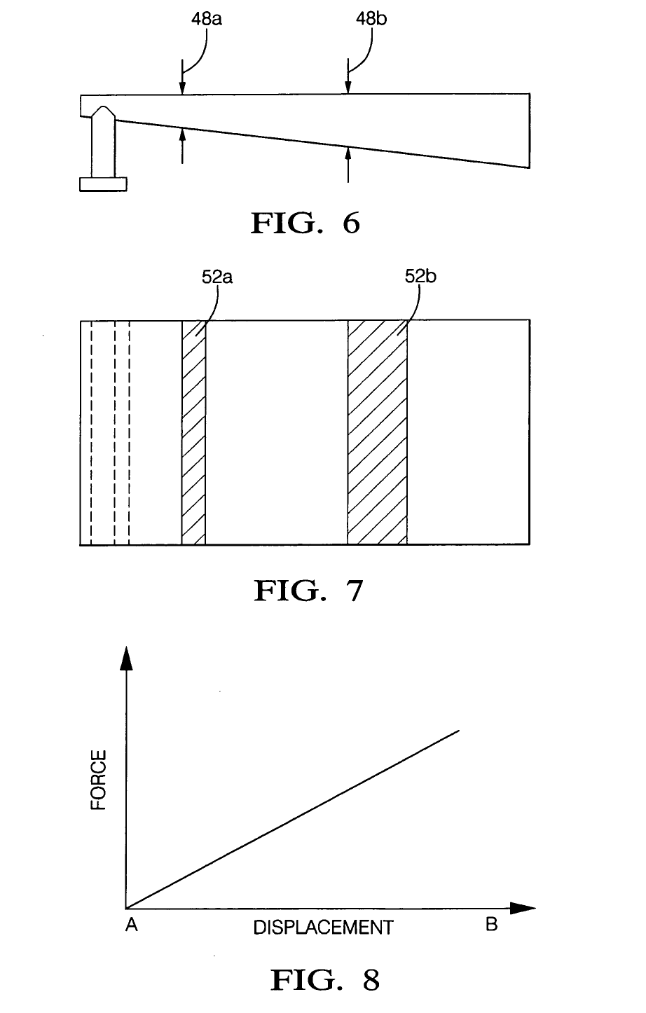

FIGS. 6-8 represent an alternative embodiment of E/A mechanism 25. In this second embodiment, the metallic foam member is similar to member 38 but has a transverse width that varies over the axial length of the foam member. As can be understood with reference to FIG. 6, the transverse width of the metallic foam member is greater than transverse gap 46 and gets increasingly larger at greater distances from gap 46, i.e., relatively small transverse width 48a is positioned closer to the transverse gap than the larger transverse width 48b before collapse of housing 22. As can be seen in FIG. 7, the metallic foam member of this second embodiment has a constant lateral dimension and, thus, the cross sectional area of the foam member at the location of transverse width 48a will be smaller than the cross sectional area of the foam member at the location of transverse width 48b. These different values of the cross sectional areas are graphically represented in FIG. 7 as the cross hatched area 52a and 52b. Cross sectional areas 52a, 52b represent the cross sectional area of metallic foam member 38 taken through a plane oriented perpendicular to the axial direction, in an undeformed condition, and are superimposed on FIG. 7 at the location of these cross sectional areas. FIG. 8 represents an E/A profile for the second embodiment. Similar to FIG. 5, FIG. 8 is a simplified and idealized E/A profile, not an actual measured profile.

As can be seen in FIG. 8, by varying the cross sectional area of the metallic foam block (which is an aluminum foam block having a density and other physical properties that are substantially uniform throughout the block), the force exerted by the foam block to resist the collapse of housing 22 can be controlled. For the embodiment illustrated in FIGS. 6-8, the increasing transverse thickness and the resulting increase in the cross sectional area of the metallic foam block cause the E/A profile to have a resistance force that increases as the relative displacement of the first and second members 26, 32 increase and an increasingly thicker portion of the metallic foam member is forced through transverse gap 46.

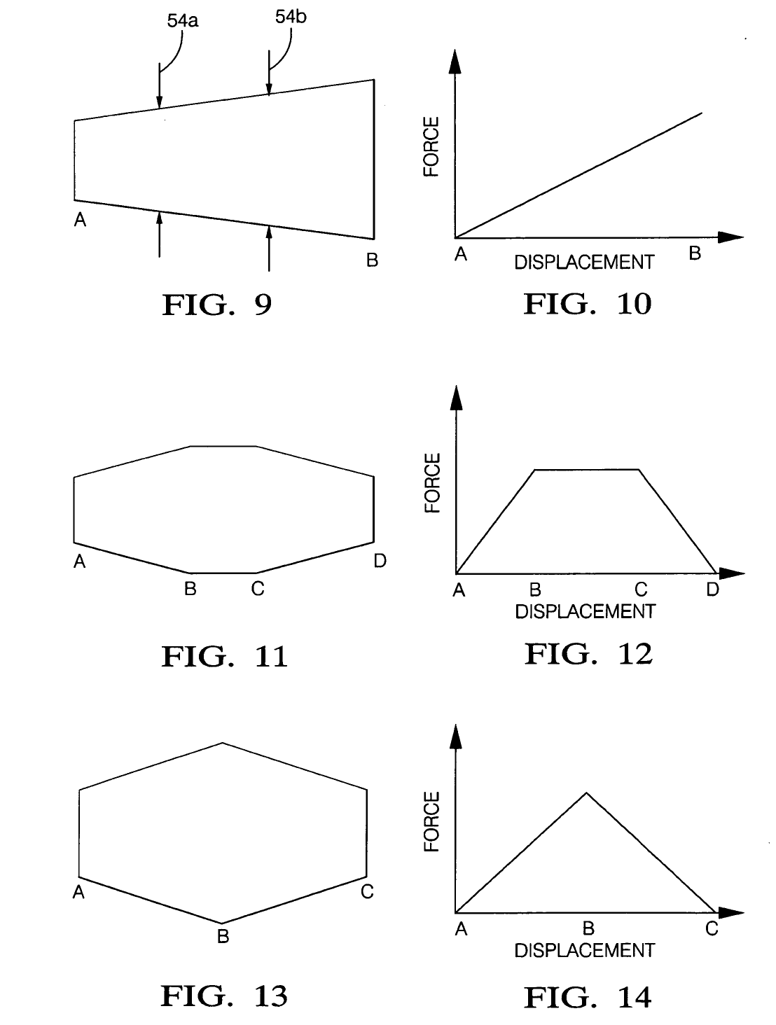

FIGS. 9 and 10 represent another embodiment of E/A mechanism 25 wherein the metallic foam member has a lateral dimension that varies over the axial length of the foam member. As can be seen in the schematic top view of FIG. 9, lateral dimension 54a is relatively close to transverse gap 46 (prior to collapse of housing 22) and is smaller than the more distant lateral dimension 54b. The metallic foam block of FIGS. 9 and 10 is an aluminum foam block having a constant transverse thickness and substantially uniform physical properties. Similar to the embodiment discussed above with reference to FIGS. 6-8, this third embodiment illustrated in FIG. 9 provides a metallic foam block that has a progressively increasing cross sectional area. This third embodiment, however, increases the lateral dimension of the metallic foam block instead of the transverse thickness of the metallic foam block. FIG. 10 represents an E/A profile for the third embodiment of the metallic foam member depicted in FIG. 9 and illustrates the progressively increasing resistance force generated by the increasing cross sectional area of the foam block. Similar to FIGS. 5 and 8, FIG. 10 is a simplified and idealized E/A profile, not an actual measured profile.

FIGS. 11 and 12 represent another embodiment of E/A mechanism wherein the metallic foam member is an aluminum foam member having a constant transverse thickness and substantially uniform physical properties. As shown in the schematic top view of FIG. 11, the lateral dimension of the metallic foam member initially increases from axial location A to axial location B, remains constant between axial locations B and C, and progressively decreases from axial location C to axial location D. FIG. 12 represents an E/A profile for this fourth embodiment of the metallic foam member depicted in FIG. 11. Similar to FIGS. 5, 8 and 10, FIG. 12 is a simplified and idealized E/A profile, not an actual measured profile.

This embodiment illustrates an advantage of transverse gap 46 in comparison to a simple axial compression of the metallic foam member. By including a section, i.e., from axial location C to axial location D, wherein the cross sectional area of the metallic foam member progressively decreases as it enters the transverse gap, the force exerted by the metallic foam block resisting the collapse of housing 22 will progressively decrease as housing 22 collapses (see section C-D of the E/A profile presented in FIG. 12). For a metallic foam member that is subject to a simple axial compression on the other hand, the member will initially collapse at its weakest location and all further compression will likewise take place at the point of weakest resistance. Thus, the resistance force created by such an axially compressed member will either increase or remain constant as the housing collapses but will not progressively decrease as provided by the E/A mechanism of FIG. 11.

FIGS. 13 and 14 represent another embodiment of E/A mechanism 25 which includes a progressively decreasing resistance force for at least a portion of the relative collapse of the mechanism. In this embodiment, the metallic foam member is an aluminum foam block with a constant transverse thickness and substantially uniform physical properties. The foam block has an increasing lateral dimension between axial locations A and B and a decreasing lateral dimension between axial locations B and C. As a result, in the first stage of displacement, when the axial section between A and B enters the transverse gap, the resistance force progressively increases while in the second stage of displacement, when the axial section between B and C enters the transverse gap, the resistance force progressively decreases. FIG. 14 represents an E/A profile for this fifth embodiment of the metallic foam member depicted in FIG. 13. Similar to FIGS. 5, 8, 10 and 12, FIG. 14 is a simplified and idealized E/A profile, not an actual measured profile.

As can be seen from the E/A mechanisms of FIGS. 11 and 13, by providing the foam block with a diminishing section, i.e., axial section C to D in FIG. 11 and B to C in FIG. 13, wherein the undeformed cross sectional area of the foam member entering the transversely extending open gap 46 progressively decreases as the first and second housing members move from an initial configuration toward a collapsed configuration, a progressively decreasing resistance force can be generated. Alternative configurations of the foam block may also be used to provide such a diminishing cross sectional area, e.g., the transverse thickness of the block could be reduced instead of the lateral dimension of the block.

Because the foam block used in the embodiment of FIGS. 1 and 2 communicates an axial compression force between surface 42a and the point where the foam block is forced into transverse gap 46, it is, in some extreme designs of the foam block, possible that the transmitted axial force would be greater than the force necessary to axially compress the weakest portion of the foam block. In such a case, axial compression of the foam block would occur until the foam block was capable of axially resisting the force necessary to force the block through transverse gap 46. This is likely to be a problem only in extreme designs and could be at least partially overcome by using an adhesive to secure the foam block to an appropriate one of the relatively collapsible housing members, e.g., surface 42b in the embodiment of FIGS. 1 and 2, so that the entire axial length of the foam block was not required to bear the full axially directed force necessary to force the foam block through transverse gap 46. Axially spaced mechanical interlocks or fasteners and other appropriate securing means could also be employed instead of an adhesive for this same purpose.

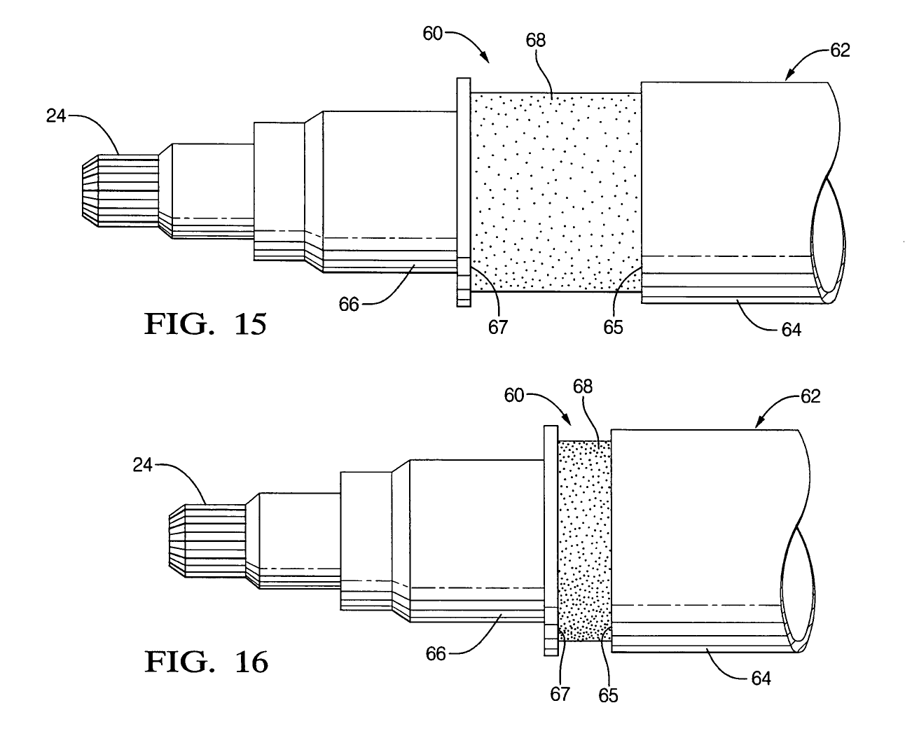

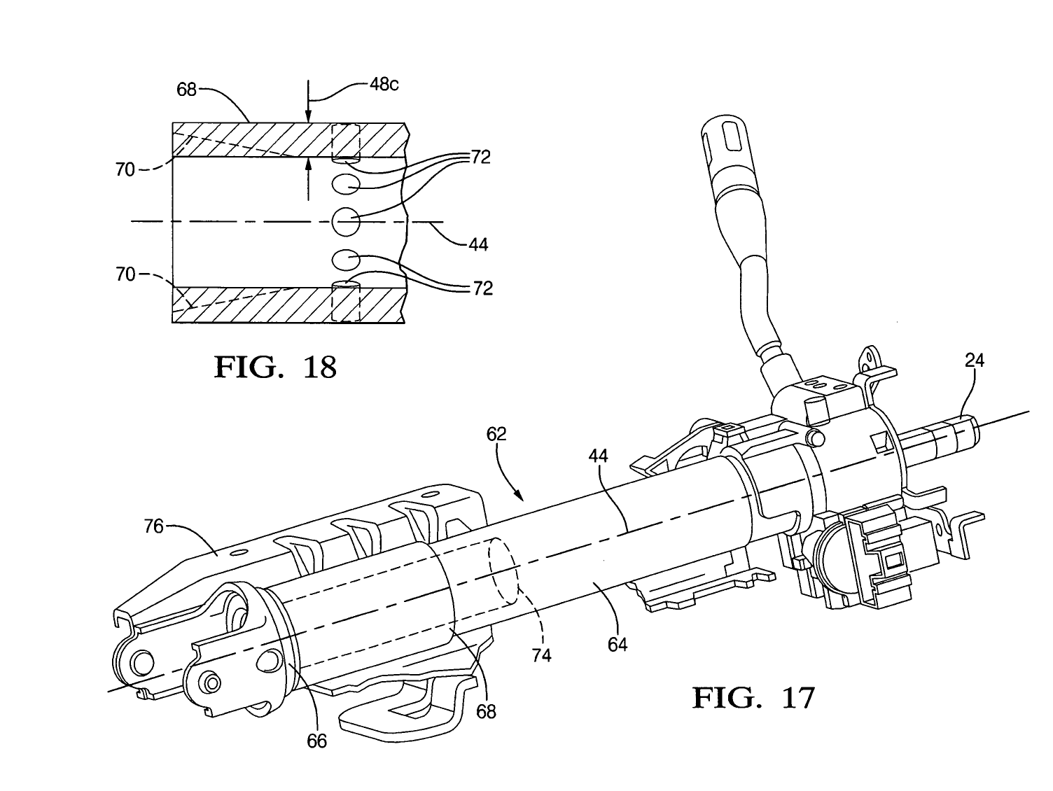

Turning now to FIGS. 15-18, the use of another E/A mechanism 60 with a collapsible housing 62 is illustrated. In this embodiment, a first relatively large diameter cylindrical member 64 and a second relatively smaller diameter cylindrical member 66 with an internal sleeve 74 are arranged in a telescoping fashion to form a collapsible housing within which a steering shaft 24 is disposed. A mounting fixture 76 is non-moveably fixed to the vehicle structure and supports housing 62. A hollow cylindrical metallic foam member 68 is operably disposed between the first and second members 64, 66. First member 64 includes a first engagement portion 65 that engages one axial end of metallic foam member 68 and second member 66 includes a second engagement portion 67 that engages the opposite axial end of aluminum foam member 68. First and second engagement portions 65, 67 and metallic foam member form E/A mechanism 60 and resist the axial collapse of housing members 64, 66.

FIG. 15 illustrates housing 62 and E/A mechanism 60 in an initial configuration prior to collapse of the housing 62. FIG. 16 schematically illustrates housing 62 and E/A mechanism 60 after first and second members 64, 66 have moved relative to each other and axially compressed metallic foam member 68 between engagement portions 65, 67. Hollow cylindrical metallic foam member 68 is shown in a cross sectional view in FIG. 18. E/A mechanism 60 utilizes a simple axial compression of metallic foam member 68 to absorb the energy of an impact. As a result, the weakest portion of metallic foam member 68 will be compressed during the collapse of housing 62. If the physical properties of metallic foam member 68 are substantially uniform and transverse thickness 48c (FIG. 18) of the cylindrical wall forming foam member 68 is substantially constant, the resistance force provided by E/A mechanism 60 will be substantially constant. To provide a varying resistance force, transverse thickness 48c could be varied such as indicated by dashed lines 70 in FIG. 18. It is also possible to place apertures 72 in metallic foam member 68 to provide an area of decreased axial resistance and thereby vary the resistance force generated by metallic foam member 68.

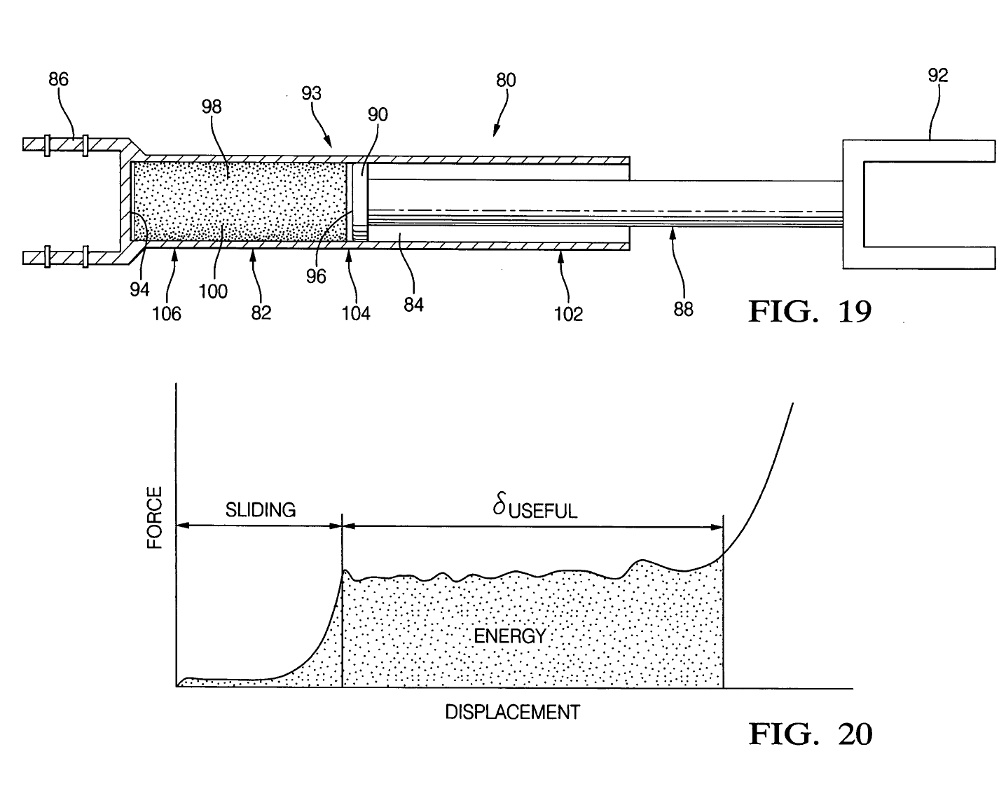

Turning now to FIGS. 19-24, three different embodiments of collapsible steering shafts which can be positioned within a steering column housing and are operably disposed in the linkage communicating rotational motion between a steering wheel and steering gear are disclosed. Many known collapsible shaft designs utilize E/A mechanisms that function well when struck with an axially directed impact force but do not function as well when struck with a force delivered at an angle to the shaft axis. For example, the performance of thin walled metal tubes which are designed to buckle into a series of regular ring-like folds will be adversely affected when struck with an impact force that is not aligned with the axis of tube. The E/A mechanisms of the collapsible tubes described below all include a metallic foam members. Although the performance of the E/A mechanisms will depend upon many factors in addition to the member used to absorb the impact force, one advantage associated with metallic foam members is that such members can absorb and cushion impact forces from any direction and are not inherently limited to absorbing precisely applied axial loads.

A first collapsible shaft 80 is illustrated in FIG. 19 and an E/A profile of shaft 80 is presented in FIG. 20. Collapsible shaft 80 includes a first shaft member 82 with a hollow interior 84 and a connector 86 at one end. Second shaft member 88 is telescopingly received in hollow interior 84 and includes a plunger head 90 and a connector 92. Plunger head 90 and the hollow interior 84 of shaft 82 have cooperating shapes that allow plunger head 90 to slide axially within hollow interior 84 to thereby collapse shaft 80. Plunger head 90 and hollow interior 84 are non-circular, however, so that the rotation of second shaft member 88 will result in the rotation of first shaft member 82. Connectors 86, 92 are used to connect shaft 80 to linkages in the steering mechanism. For example, connector 92 may be connected in a universal joint connection proximate the steering wheel of the vehicle to provide a tiltable steering wheel as is well known in the art.

Collapsible shaft 80 includes an E/A mechanism 93 that is formed by a metallic foam member 100 that is disposed between engagement portions 94 and 96 of the two telescoping shaft members. First engagement portion 94 is formed by the axially facing bottom surface of hollow interior 84 while the second engagement portion 96 is formed by the axially facing surface of plunger head 90. Metallic foam member 100 is located in the volume 98 between engagement surfaces 94, 96. The initial position of plunger head 90 when installed in a steering column and before experiencing an impact is indicated by arrow 102. As shaft 80 is collapsed, plunger head 90 slides within shaft member 82 until plunger head 90 engages metallic foam member 100 at location 104. As shaft 80 is further collapsed from axial position 104 toward axial position 106, metallic foam member 100 is axially compressed and thereby absorbs part of the impact force. The E/A profile schematically depicts the resistance force exerted by E/A mechanism 93. The first stage of the E/A profile is labeled “SLIDING” and corresponds to the sliding of plunger head 90 within shaft member 82 from axial position 102 to axial position 104. As can be seen in the E/A profile of FIG. 20, the sliding of plunger head through this length of shaft member 82 does not generate any significant force resisting the collapse of shaft 80. Once plunger head 90 engages metallic foam member 100, however, E/A mechanism 93 exerts a more significant resistance force as metallic foam member 100 is axially compressed. This second stage of displacement, as plunger head 90 moves from axial location 104 toward axial location 106, is labeled “δ_{USEFUL}” in the E/A profile of FIG. 20. The area under the profile represents the energy that is “absorbed” by E/A mechanism 93 as shaft 80 is collapsed. At a certain point, proximate axial location 106, metallic foam member 100 will have been substantially compressed and the axial force required to further axially compress metallic foam member 100 will substantially increase.

In the illustrated embodiment, metallic foam member 100 has substantially uniform physical properties and a substantially solid columnar shape. Thus, the second stage of displacement, “δ_{USEFUL}” in FIG. 20, provides a relatively constant resistance force. It is further noted that the E/A profile depicted in FIG. 20 is not an actual measured profile but is an estimated profile that shows a substantially constant resistance force for each of the two depicted stages of displacement which includes some random variation as would be expected in an actual measured profile.

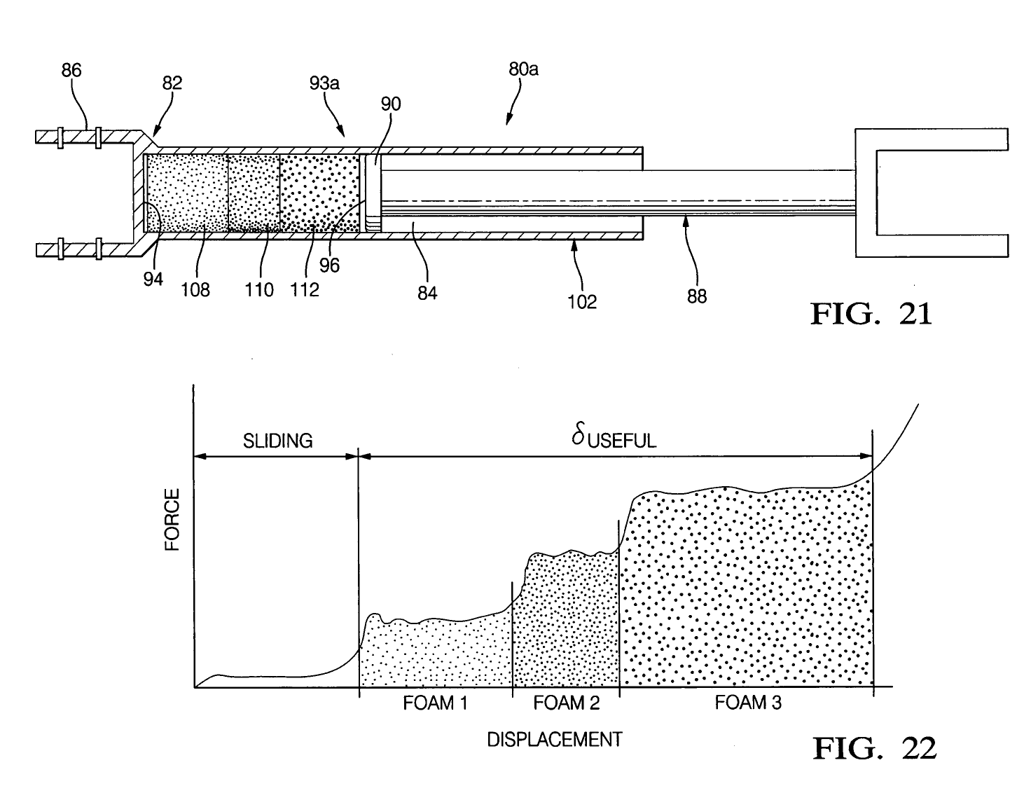

A second collapsible shaft 80a is illustrated in FIG. 21 and an E/A profile of shaft 80a is presented in FIG. 22. This embodiment is similar to collapsible shaft 80 with three separate metallic foam members 108, 110 and 112 replacing metallic foam member 100. The three separate metallic foam members 108, 110 and 112 are all aluminum foam members having a common cross sectional shape. The three foam members, however, have different densities, with member 108 having the lowest density and member 112 having the greatest density. As a result, when the three metallic foam members are compressed between engagement surfaces 94 and 96, the least dense metallic foam member 108 will initially be compressed, followed by member 110 and then member 112. The resulting E/A profile takes the form of a stair step progression as depicted in FIG. 22. As can be seen in FIG. 22, the E/A profile has four distinct stages, the first stage offers substantially no resistance as plunger head 90 slides within shaft member 82 from axial position 102 until it engages the metallic foam member 112. The second stage, labeled “FOAM 1” corresponds to the compression of metallic foam member 108; the third stage labeled “FOAM 2” corresponds to the compression of metallic foam member 110; and the fourth stage labeled “FOAM 3” corresponds to the compression of metallic foam member 112. It is noted that the E/A profile depicted in FIG. 22 is not an actual measured profile but is an estimated profile that includes four substantially constant sections each with some random variation as would be expected in an actual measured profile.

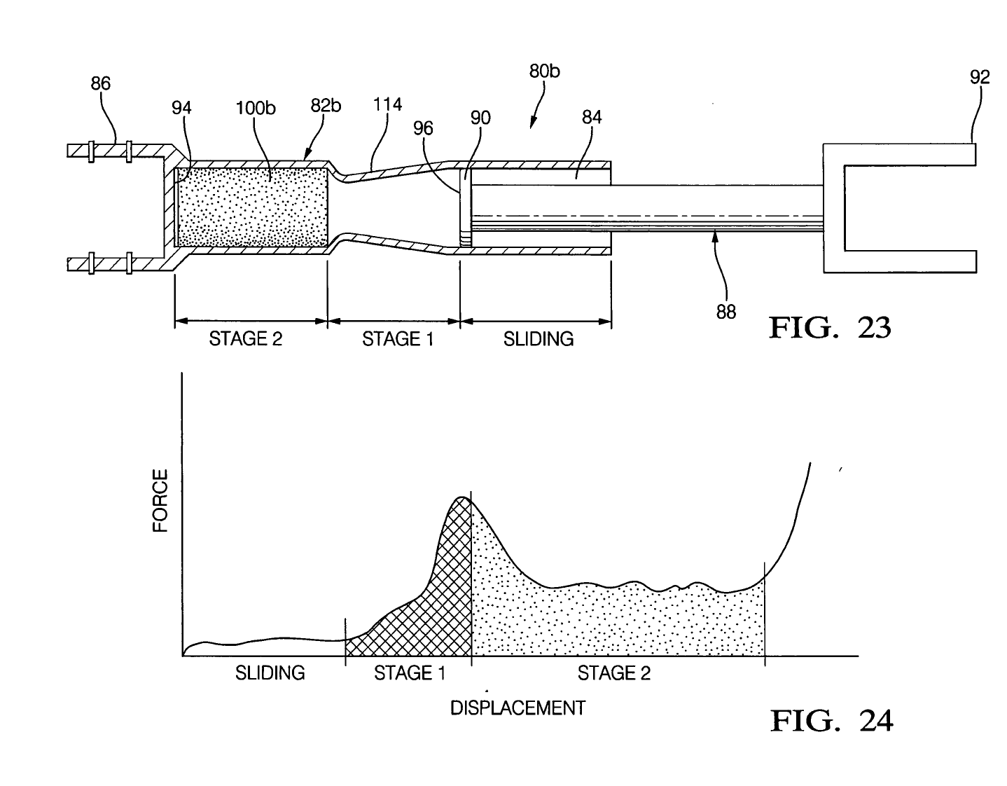

A third collapsible shaft 80b is illustrated in FIG. 23 and an E/A profile of shaft 80b is presented in FIG. 24. This embodiment represents another modification to collapsible shaft 80 illustrated in FIG. 19. First shaft member 82b has been modified to include inward sloping side walls 114 to provide some resistance to the axial collapse of shaft 80b before plunger head 90 engages metallic foam member 100b. When shaft 80b is collapsed, plunger head 90 will initially slide through hollow interior 84 with minimal resistance, i.e., through the axial section labeled “SLIDING” in FIG. 23. The E/A profile depicted in FIG. 24 also includes a section labeled “SLIDING” which corresponds to this initial stage of collapse.

When plunger head 90 reaches the axial location at which it is located in FIG. 23, inward sloping sidewalls 114 will resist the further relative axial movement of plunger head 90 toward surface 94 through the section labeled “STAGE 1” in FIG. 23. Sidewalls 114 are configured such that the resistance generated by sidewalls 114 becomes increasingly larger as plunger head 90 progresses toward surface 94 as can be seen from the section labeled “STAGE 1” in the E/A profile of FIG. 24. Various other modifications to collapsible shaft 80 may be alternatively be used to provide the shaft with an axial section that resists the collapse of the shaft without engaging the metallic foam member. Examples of such alternative structures are disclosed by Urista et al. in U.S. Pub. No. 2005/0077716 A1 which is hereby incorporated herein by reference.

Metallic foam member 100b is a solid columnar aluminum foam member having substantially uniform physical properties. As plunger head 90 compresses metallic foam member 100b as it travels through the axial section labeled “STAGE 2” in FIG. 23, it will be subjected to a substantially constant resistance force as represented in FIG. 24 by the E/A profile section labeled “STAGE 2.” It is noted that the E/A profile depicted in FIG. 22 is not an actual measured profile but is an estimated profile that has been drawn to include some random variation as would be expected in an actual measured profile.

Although each of the three collapsible shafts discussed above included an initial stage wherein the two telescoping shaft members slid relative to each other with minimal resistance, such a sliding stage could be omitted if desired. With regard to such design modifications, it will be recognized by those having ordinary skill in the art that total resistance force of the steering assembly will be dependent upon the combination of resistance forces exerted by both the collapsible rotating shaft and the collapsible outer housing. Thus, the summation of the E/A profiles of the shaft and housing will provide the combined E/A profile of the entire steering column assembly.

While this invention has been described as having an exemplary design, the present invention may be further modified within the spirit and scope of this disclosure. This application is therefore intended to cover any variations, uses, or adaptations of the invention using its general principles.

What is claimed is:

1. An energy absorption mechanism for a collapsible assembly, said mechanism comprising:
a first member and a second member wherein said first and second members are relatively displaceable as said assembly is collapsed, said first and second members being relatively displaced from an initial configuration to a collapsed configuration during collapse of said assembly;
said first member defining a first engagement portion and said second member defining a second engagement portion wherein said first and second engagement portions define a variable volume therebetween; said volume having an axial extent that is progressively reduced as said first and second members move from said initial configuration toward said collapsed configuration, said first and second engagement portions further defining an open gap extending in a direction transverse to said axial direction; and
a metallic foam member operably disposed between said first and second engagement portions, said metallic foam member positioned to resist relative axial movement of said first and second members from said initial configuration toward said collapsed configuration, said metallic foam member having an axially extending first portion with a transverse thickness greater than said transversely extending open gap, said metallic foam member being deformed as said first and second members move from said initial configuration toward said collapsed configuration with said first portion of said metallic foam member entering said transverse gap during said movement from said initial configuration toward said collapsed configuration.

2. The energy absorption mechanism of claim 1 wherein said transverse dimension of said metallic foam member, in an undeformed condition, varies over the axial length of said first portion of said metallic foam member and wherein deformation of said metallic foam member between said first and second engagement portions generates a resistance force that varies as said first and second members move from said initial configuration toward said collapsed configuration.

3. The energy absorption mechanism of claim 1 wherein said first portion of said metallic foam member defines a laterally extending width, wherein said lateral, transverse and axial directions are all substantially mutually perpendicular, wherein said lateral width of said metallic foam member, in an undeformed condition, varies over the axial length of said first portion of said metallic foam member and wherein deformation of said metallic foam member between said first and second engagement portions generates a resistance force that varies as said first and second members move from said initial configuration toward said collapsed configuration.

4. The energy absorption mechanism of claim 1 wherein said first portion of said metallic foam member defines a cross sectional area through a plane oriented perpendicular to said axial direction, in an undeformed condition, that is variable in magnitude over the axial length of said first portion and wherein deformation of said metallic foam member between said first and second engagement portions generates a resistance force that varies as said first and second members move from said initial configuration toward said collapsed configuration.

5. The energy absorption mechanism of claim 4 wherein said first portion of said metallic foam member includes a diminishing section wherein said undeformed cross sectional area of said foam member entering said transversely extending open gap progressively decreases as said first and second members move from said initial configuration toward said collapsed configuration and wherein said resistance force decreases as said first and second members move from said intial configuration toward said collapsed configuration as said diminishing section enters said gap.

6. The energy absorption mechanism of claim 1 wherein said collapsible assembly is a steering assembly for a vehicle and said first member is adapted to be non-moveably fixed to the vehicle and said second member is adapted to be relatively moveable to both said first member and said vehicle during collapse of said steering assembly.

7. A collapsible steering assembly for a vehicle, said assembly comprising:
a collapsible housing mountable to the vehicle;
a collapsible steering shaft disposed within said housing;
an energy absorption mechanism operably coupled with one of said housing and said steering shaft; movement of said energy absorption mechanism from an initial configuration to a collapsed configuration resisting collapse of said one of said housing and said steering shaft, said energy absorption mechanism comprising:
a first member and a second member wherein said first and second members are relatively displaceable through a first stage of displacement and a second stage of displacement during movement of said energy absorption mechanism from said initial configuration to said collapsed configuration;
said energy absorption mechanism generating a collapse resisting force with a first magnitude during said first stage of displacement and a different second magnitude during said second stage of displacement; and
a metallic foam member operably disposed between said first and second members wherein relative movement of said first and second members during one of said first and second stages of displacement deforms said metallic foam member, said deformation of said metallic foam member generating said collapse resisting force for said one stage.

8. The collapsible steering assembly of claim 7 further comprising a second metallic foam member operably disposed between said first and second members wherein relative movement of said first and second members during the other of said first and second stages of displacement deforms said second metallic foam member, said deformation of said second metallic foam member generating said collapse resisting force for said other stage.

9. The collapsible steering assembly of claim 8 wherein said metallic foam member and said second metallic foam member have different densities.

10. The collapsible steering assembly of claim 7 wherein relative displacement of said first and second members defines a displacement axis, said metallic foam member defining a cross sectional area through a plane oriented perpendicular to said displacement axis, a first section of said metallic foam member defining a first cross sectional area and a second section of said metallic foam member defining a second cross sectional area, said first section of said metallic foam member being deformed during said first stage of displacement and said second section of said metallic foam member being deformed during said second stage of displacement.

11. The collapsible steering assembly of claim 10 wherein said metallic foam member has a substantially constant density in both said first and second sections of said metallic foam member.

12. The collapsible steering assembly of claim 7 wherein said energy absorption mechanism is operably coupled with said collapsible steering shaft, said first member being a shaft member defining a hollow interior volume and said second member being a shaft member telescopingly received in said interior volume of said first member wherein said first and second stages of displacement include the telescoping displacement of said second member within said interior volume of said first member, said metallic foam member disposed within said hollow interior volume and being deformed by said relative telescoping movement of said first and second members during said one stage.

13. The collapsible steering assembly of claim 12 further comprising a second metallic foam member operably disposed within said hollow interior volume wherein relative telescoping movement of said first and second members during the other of said first and second stages of displacement deforms said second metallic foam member, said deformation of said second metallic foam member generating said collapse resisting force for said other stage.

14. The collapsible steering assembly of claim 7 wherein said energy absorption mechanism is operably coupled with said collapsible steering shaft, said first member being a shaft member defining a hollow interior volume and said second member being a shaft member telescopingly received in said interior volume of said first member wherein said first and second stages of displacement include the telescoping displacement of said second member within said interior volume of said first member, telescoping movement of said second member within said interior volume of said first member through said first stage of displacement deformationally engaging said first and second members; telescoping movement of said second member within said interior volume of said first member through said second stage of displacement deformationally engaging said second member with said metallic foam member.

15. The collapsible steering assembly of claim 7 wherein relative displacement of said first and second members defines a displacement axis, said first and second members defining an open gap extending in a direction transverse to said displacement axis, relative displacement of said first and second members along said displacement axis deformationally forcing at least a portion of said metallic foam member into said transverse gap.

16. The collapsible steering assembly of claim 15 wherein said metallic foam member defines a cross sectional area through a plane oriented perpendicular to said displacement axis, a first section of said metallic foam member defining a first cross sectional area and a second section of said metallic foam member defining a second cross sectional area, said first section of said metallic foam member deformationally entering said transverse gap during said first stage of displacement and said second section of said metallic foam member deformationally entering said transverse gap during said second stage of displacement.

17. The collapsible steering assembly of claim 7 further comprising a second energy absorption mechanism operably coupled with the other one of said housing and said steering shaft, movement of said second energy absorption mechanism from an initial configuration to a collapsed configuration resisting collapse of said other one of said housing and said steering shaft, said second energy absorption mechanism comprising:
a third member and a fourth member, said third and fourth members being relatively displaceable; and
a second metallic foam member operably disposed between said third and fourth members wherein relative movement of said third and fourth members deforms said second metallic foam member, said deformation of said metallic foam member generating a force resisting collapse of said other one of said housing and said steering shaft.

18. A method of absorbing energy during the collapse of a steering assembly in a vehicle, said method comprising:
disposing a metallic foam member between first and second relatively displaceable members wherein the first and second displaceable members are relatively moveable along a displacement axis during collapse of the steering assembly;
forming an open gap between the first and second displaceable members wherein the gap extends transverse to the displacement axis; and
forcing at least a portion of the metallic foam member into the open gap during collapse of the steering assembly and thereby causing the deformation of the metallic foam member.

19. The method of claim 18 wherein the metallic foam member defines, in an undeformed condition, a cross sectional area in a plane oriented perpendicular to the displacement axis that is variable in magnitude over the axial length of the metallic foam member that deformationally enters the open transverse gap during the collapse of the steering assembly and wherein the deformation of the metallic foam member generates a resistance force that varies as the steering assembly is progressively collapsed.

20. The method of claim 19 wherein the metallic foam member includes a diminishing section wherein the undeformed cross sectional area of the metallic foam member entering the open transverse gap progressively decreases as the steering assembly is progressively collapsed whereby the resistance force generated by the metallic foam member to the collapse of the steering assembly is progressively decreased.
